(19) United States
(12) Patent Application Publication
(10) Pub. No.: US 2026/0238027 A1
(43) Pub. Date: Aug. 13, 2026

(54) RECEPTACLE FOR A BATTERY PACK

(71) Applicant: Andreas Stihl AG & Co. KG, Waiblingen (DE)

(72) Inventors: Christian Uhlmann, Erlangen (DE); Florian Klein, Esslingen am Neckar (DE)

(21) Appl. No.: 19/535,972

(22) Filed: Feb. 10, 2026

(30) Foreign Application Priority Data
Feb. 12, 2025 (DE) 10 2025 105 096.1

(51) Int. Cl. H02J 7/70

(52) U.S. Cl. CPC H02J 7/731

(57) ABSTRACT

A receptacle is for a battery pack with electrical connection contacts. The receptacle has electrical mating contacts corresponding to the electrical connection contacts. The receptacle is configured to push the battery pack by a push-in distance in a push-in direction into a contact position in the receptacle. In the contact position, the electrical mating contacts of the receptacle are electrically conductively connected to the electrical connection contacts of the battery pack. To protect the battery pack against deep discharging, provision is made for the receptacle to have a disconnection device for disconnecting the electrical connection between the electrical mating contacts and the electrical connection contacts of the battery pack. The disconnection device is configured to receive a disconnection signal to disconnect the electrical connection between the electrical mating contacts and the electrical connection contacts when the disconnection signal is received.

### CROSS-REFERENCE TO RELATED APPLICATIONS

This application claims priority of German patent application no. 10 2025 105 096.1, filed February 12, 2025, the entire content of which is incorporated herein by reference.

### TECHNICAL FIELD

The disclosure relates to a receptacle for a battery pack with electrical connection contacts, wherein the receptacle has electrical mating contacts corresponding to the electrical connection contacts in the receptacle. The receptacle is configured to push the battery pack by a push-in distance in a push-in direction into a contact position in the receptacle. In the contact position, the electrical mating contacts of the receptacle are electrically conductively connected to the electrical connection contacts of the battery pack.

### BACKGROUND

If battery packs remain in a work apparatus after active use or in a charger after a discharge process, there is a risk of undesired deep discharging due to leakage currents and/or the power requirement of an electronics system, for example a battery management system. If a battery pack is subject to deep discharging, this can trigger irreversible processes in the individual cells and limit the power of the battery pack or render the battery pack unusable. A battery pack may also remain in a charger and be exposed to voltage peaks, for example after a charging process.

### SUMMARY

It is an object of the disclosure to provide a receptacle for a battery pack in a work apparatus or a charger which provides better protection for the battery pack.

According to the disclosure, provision is made for the receptacle to have a disconnection device which enables disconnection of the electrical connection between the electrical mating contacts of the receptacle and the electrical connection contacts of the battery pack in the contact position of the battery pack. In order to trip the disconnection device, a disconnection signal is fed to the disconnection device, wherein the disconnection device is configured to receive a disconnection signal in order to disconnect the electrical connection between the electrical mating contacts and the connection contacts when the disconnection signal is received.

This can be done by either the battery pack with its connection contacts being pushed out counter to the push-in direction or along the push-in direction by a travel distance or else the mating contacts being retracted in the push-in direction or in a direction away from the battery pack, so that the connection contacts of the battery pack and the mating contacts in the receptacle are disconnected. As an alternative or in addition, the disconnection can also be performed electronically.

The receptacle can be a battery compartment. The receptacle can also include a rail which is configured to receive the battery pack by the battery pack sliding onto the rail. Such embodiments are also referred to as sliders or can be understood to be part of a slider system. In addition, it is possible for the receptacle to be configured as an adapter for a battery pack or to be arranged on a battery pack. The receptacle can also be part of a charger or an electric work apparatus.

In order actuate the disconnection device using a disconnection signal, a monitoring device is provided, which is expediently arranged in the receptacle or connected to the receptacle. The connection can be an electrical connection within a charger or a work apparatus or a (wireless) communication connection, for example to a smartphone or to a cloud. The monitoring device is configured to compare at least one parameter of the battery pack with a specified limit value and to send a disconnection signal to the disconnection device depending on the result of the comparison in order to thus trigger disconnection of the connection contacts from the mating contacts.

The parameter of the battery pack to be monitored by the monitoring device can be an end-of-charging voltage of the battery pack, a dwell time of the battery pack in the contact position, a temperature of the battery pack, a change in temperature of the battery pack, a permissible minimum battery voltage of the battery pack and/or a voltage applied to the battery pack. The end-of-charging voltage of the battery pack is expediently monitored when a battery pack is pushed into a receptacle of a work apparatus. The permissible minimum battery voltage is expediently monitored when a battery pack is pushed in into a receptacle of a work apparatus or charger. The dwell time of the battery pack in a receptacle can be monitored both in a charger or a work apparatus.

The temperature and/or the change in temperature is expediently a temperature and/or change in temperature of the battery pack which can be tapped off using appropriate temperature sensors, for example. Depending on the application, for example in the case of a charger with a limited power supply, such as a mobile charger for example, the battery pack can also be ejected at low voltages, that is, if, for example, charging has not been performed for an excessively long time. Accordingly, the parameter can also be a voltage applied to the battery pack, in particular a charging voltage. The parameter can also be formed by a combination of the end-of-charging voltage of the battery pack, the dwell time of the battery pack in the contact position, the temperature, the change in temperature, the permissible minimum battery voltage of the battery pack and/or the voltage applied to the battery pack.

In various embodiments of the disclosure, provision is made to configure the disconnection device as a mechanical disconnection device. Provision can thus be made for the disconnection device to include a force source for providing a push-out force directed against the push-in direction and the energy force source to be configured to move the battery pack counter to the push-in direction, for example by a travel distance, into an intermediate position.

A disconnection device having a force source for providing a mechanical force can also be provided to move the mating contacts of the receptacle in a direction away from the battery pack. Therefore, a force from the force source can act on the mating contacts in the receptacle in the push-in direction in order to move them and disconnect them from the connection contacts, while the position of the battery pack remains unchanged.

If, when the disconnection device is tripped, the battery pack is moved to an intermediate position counter to the push-in direction, provision can thus be made to configure the receptacle in such a way that the battery pack is held secured in the intermediate position.

The force source for providing a disconnection force can be an electrical, magnetic, pneumatic or a mechanical force source. The force source is, in particular, an energy storage device, which is advantageously configured as a spring force accumulator. The spring force accumulator is configured in such a way that it is preloaded by the battery pack pushed into its contact position.

Provision is advantageously made for the receptacle to have a locking device and the locking device to be configured to hold the battery pack secured in its contact position. The disconnection device is configured, in particular, to release the locking of the battery pack, so that the preloaded spring force accumulator can be relieved of loading by way of pushing the battery pack out of its contact position counter to the push-in direction until the connection contacts are electrically isolated from the mating contacts.

According to a method for protecting a battery pack, provision is made for the battery pack to be pushed by a push-in distance in a push-in direction into a contact position in a receptacle, wherein electrical connection contacts of the battery pack are electrically conductively connected to the electrical mating contacts arranged in the receptacle. According to the method, at least one parameter of the battery pack is monitored and compared with a specified limit value. A disconnection signal is generated depending on the result of the comparison of the parameter with the specified limit value and sent to the disconnection device of the receptacle in order to disconnect the electrical connection contacts of the battery pack from the electrical mating contacts of the receptacle.

The parameters provided can be the end-of-charging voltage of the battery pack, the dwell time of the battery pack in the contact position, a temperature, a change in temperature, the minimum permissible charging voltage of the battery pack and/or a voltage applied to the battery pack. Therefore, a maximum end-of-charging voltage can be provided as a limit value, the disconnection device being tripped when the limit value is exceeded. Accordingly, the specified limit value can be a minimum discharge voltage, so that the disconnection device is tripped when the charging voltage is undershot. The same applies to the temperature, the change in temperature or any voltage applied to the battery pack.

In a particular embodiment of the method, provision can be made for the specified limit value to be a discharge current of the battery pack and for the disconnection device to be tripped if the discharge current falls below a specified limit value and after a specified time period for which the discharge current undershoots the limit value elapses. This can result, for example, in a battery pack pushed into an electric work apparatus being disconnected from the mating contacts in the receptacle if the work apparatus is not used for a certain period of time.

### BRIEF DESCRIPTION OF DRAWINGS

The invention will now be described with reference to the drawings wherein:

FIG. 1 shows a schematic representation of a charger including a battery pack pushed into a receptacle in the contact position;

FIG. 2 shows a schematic representation of the charger including the battery pack received in the receptacle after the disconnection device has been activated;

FIG. 3 shows a schematic representation of an electric work apparatus including a battery pack pushed into a receptacle in the contact position;

FIG. 4 shows a schematic representation of the electric work apparatus including the battery pack received in the receptacle after the disconnection device has been activated; and,

FIG. 5 schematically shows a flowchart of the method for protecting a battery pack.

### DETAILED DESCRIPTION

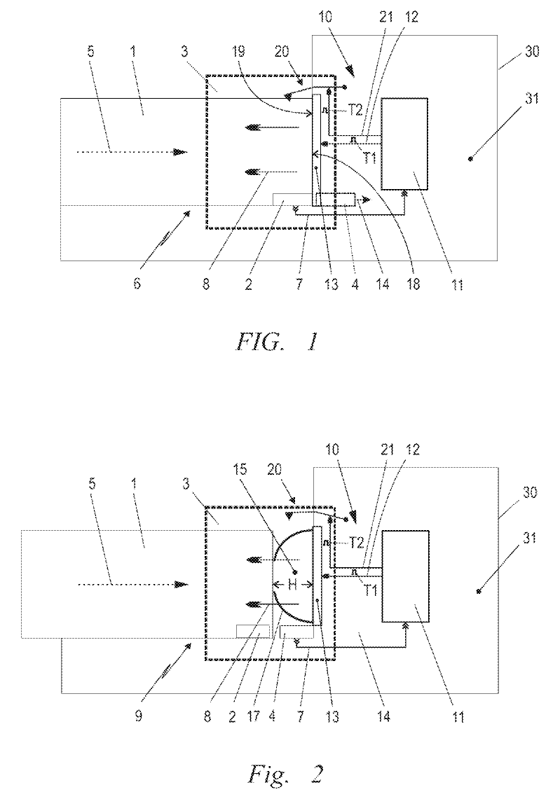

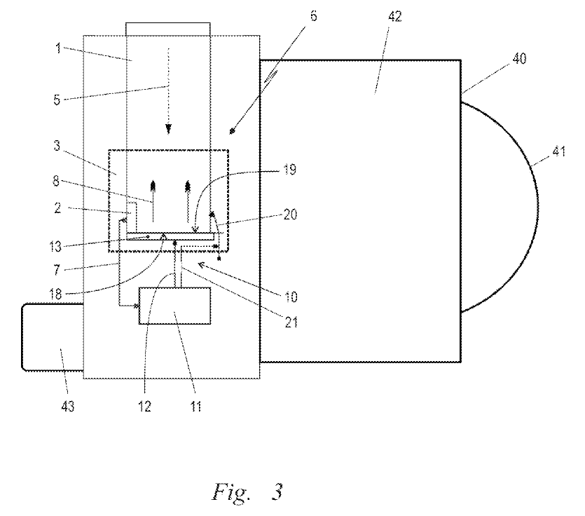

FIG. 1 shows a battery pack 1 with electrical connection contacts 2. The battery pack 1 is pushed into a receptacle 3. Electrical mating contacts 4 (FIG. 2) corresponding to the electrical connection contacts 2 of the battery pack 1 are provided in the receptacle 3. The battery pack 1 is pushed by a push-in distance in the push-in direction 5 into a contact position 6 in the receptacle 3 (FIG. 1). In this contact position 6, the electrical mating contacts 4 (FIG. 2) are mechanically contact-connected and electrically conductively connected to the electrical connection contacts 2 (FIG. 1) of the battery pack 1. Provision can be made to mechanically secure the battery pack 1 in its contact position 6 in the receptacle 3. A locking device 20 is shown by way of example.

The battery pack 1 has a connection side 18, which faces the bottom 19 of the receptacle 3. The connection contacts 2 of the battery pack 1 are provided on the connection side 18; the mating contacts 4 are arranged opposite them in the bottom 19 of the receptacle. In the contact position 6 of the battery pack 1 shown in FIG. 1, the connection side 2 is situated at the bottom 19 of the receptacle, wherein the connection contacts 2 and the mating contacts 4 are electrically contact-connected to each other.

A force source 13 is provided in the bottom 19 of the receptacle 3. The force source 13 provides a force which is directed opposite to the push-in direction 5 of the battery pack 1 and can move the battery pack 1 in the push-in direction 8. The force source 13 can be an electrical, pneumatic or mechanical force source.

The force source 13 is controlled by a monitoring device 11 which is connected to the force source 13 via a signal line 12. A locking device 20 is also provided in the shown embodiment according to FIG. 1, the locking device locking the battery pack in its contact position 6 shown specifically in FIG. 1. The locking device 20 is optional.

A disconnection device 10 is provided, this being provided for disconnecting the electrical connection between the electrical mating contacts 4 of the receptacle 3 and the electrical connection contacts 2 of the battery pack 1. The disconnection device 10 is configured to disconnect the mechanical and electrical connection between the electrical mating contacts 4 and the electrical connection contacts 2 when a disconnection signal T1 or T2 is received.

The monitoring device 11 is configured to compare at least one parameter of the battery pack 1 with a limit value stored in the monitoring device 11, in particular. The monitoring device 11 sends the disconnection signal T1 or T2 to either the force source 13 and/or the locking device 20 depending on the result of the comparison.

The monitoring device 11 is connected via a signal line 7 to the connection contacts 2 and/or the mating contacts 4 in order to tap off parameters of the battery pack 1. Parameters of this kind can be operating parameters such as an end-of-charging voltage of the battery pack 1, a dwell time of the battery pack 1 in the contact position 6 in the receptacle 3 or a permissible minimum battery voltage of the battery pack 1.

The situation of the end-of-charging voltage being reached can be used as a parameter for tripping the disconnection device 10 in a charger 30 shown in FIGS. 1 and 2. The receptacle 3 is formed in the housing 31 of the charger 30. If a stored, specified limit value of a maximum end-of-charging voltage is reached or exceeded, the monitoring device 11 will trip the disconnection device 10.

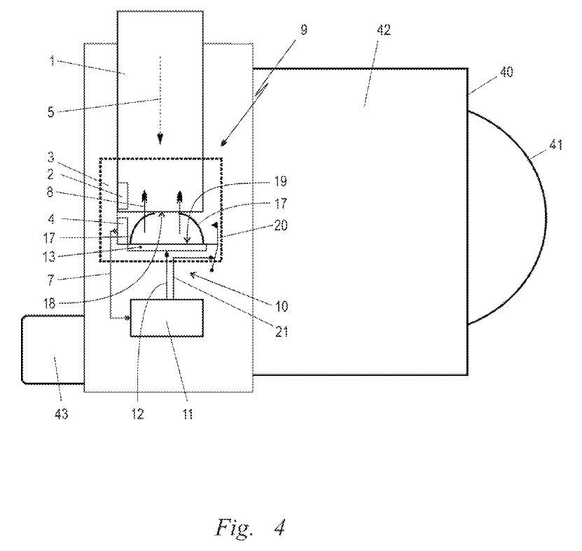

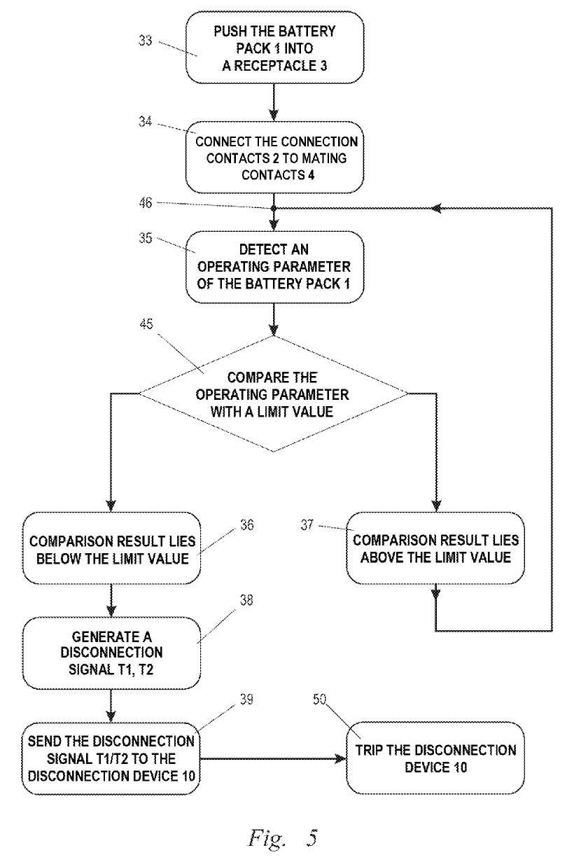

A specified limit value of a minimum discharge voltage can be used as a parameter for tripping the disconnection device 10 in an electric work apparatus 40 shown in FIGS. 3 and 4. If a specified limit value of a minimum discharge voltage of the battery pack 1 is reached or undershot, the monitoring device 11 will trip the disconnection device 10.

A specified limit value of a discharge current can also be provided as a parameter for tripping the disconnection device 10 in an electric work apparatus 40 (FIGS. 3 and 4). If the specified limit value of the discharge current is reached or undershot, the disconnection device 10 is tripped after a specified time period has elapsed.

In the embodiments shown according to FIGS. 1 to 4, the disconnection device 10 is configured as a mechanical disconnection device. The force source 13 of the disconnection device is an energy storage device, which is configured as a spring force accumulator 15 in particular, in the embodiment shown.

The force source 13 of the disconnection device 10 can be used for providing a push-out force directed counter to the push-in direction 5 in the push-out direction 8 on the battery pack 1. The force source 13 can be configured and dimensioned such that the battery pack 1 is moved counter to the push-in direction 5 into an intermediate position 9 (FIG. 2 and FIG. 4). In this intermediate position 9, the electrical connection contacts 2 of the battery pack 1 are mechanically disconnected and/or electrically isolated from the mating contacts 4 in the receptacle 3.

As an alternative, provision can be made to move the mating contacts 4 of the receptacle 3 instead of the battery pack 1 for disconnecting the connection contacts 2 from the mating contacts 4. As schematically shown in FIG. 1, the mating contacts 4 of the receptacle 3 are moved in a direction away from the battery pack 1 in the push-in direction 5 of the battery pack 1 in arrow direction 14 when the disconnection device 10 is tripped, until electrical isolation is achieved.

In FIGS. 1 and 2, the force source 13 shown is preferably a spring force accumulator 15, the spring 17 or the springs of which are loaded by the battery pack 1 being pushed in the push-in direction 5 into the receptacle 1. The springs 17 can be leaf springs, helical springs or the like. The battery pack 1 is - as shown in FIG. 1 - locked in its contact position 6 against the force of the force source 13 by the locking device 20. The loaded springs 17 of the force source 13 acting in the contact position 6 in the push-out direction 8 cannot move the battery pack 1 when the locking device 20 is active.

The monitoring device 11 is configured to release the locking device 20 when the specified limit value of the monitored parameter of battery pack 1 is reached or exceeded or, respectively, undershot. The monitoring device 11 sends a disconnection signal T2 to the locking device 20 via a signal line 21, as a result of which the locking device opens and releases the battery pack 1. The force source 13, in particular the springs 17 of the spring force accumulator 15, moves the battery pack 1 counter to the push-in direction 5 in the push-out direction 8 by a travel distance H, as a result of which the connection contacts 2 of the battery pack 1 are mechanically disconnected and electrically isolated from the mating contacts 4 of the receptacle 3.

FIGS. 3 and 4 show an electric work apparatus 40, which can be, for example, a chain saw, a blower, a brushcutter, an angle grinder or the like, in particular a portable electric work apparatus. In the embodiment shown according to FIGS. 3 and 4, the work apparatus 40 shown is a schematically illustrated angle grinder having a housing 42 and a handle 41 provided for guiding the work apparatus 40. The work apparatus 40 has a tool 43, for example a cutting disc. The housing 42 of the work apparatus 40 includes the receptacle 3 into which a battery pack 1 is pushed in the push-in direction 5. The structure, function and configuration of the disconnection device 10 correspond to those according to FIGS. 1 and 2, and for this reason the same reference signs are used for the same parts.

As shown in the schematic flowchart in FIG. 5, for the purpose of executing the method, the situation of the battery pack 1 being pushed by a push-in distance in push-in direction 5 (FIGS. 1 to 4) into a contact position 6 in an above-described receptacle 3 is initially detected according to field 33. The receptacle 3 can be the receptacle of a charger 30 or an electric work apparatus 40.

According to field 34, the electrical connection contacts 2 of the battery pack 1 are electrically conductively connected to the electrical mating contacts 4 arranged in the receptacle 3 in the contact position of the battery pack (FIGS. 1 to 4). In order to protect the battery pack 1, connection of the electrical connection contacts 2 of the battery pack 1 to the electrical mating contacts 4 arranged in the receptacle 3 and an operating parameter of the battery pack 1 are detected according to the method. An operating parameter of this kind can be an end-of-charging voltage of the battery pack 1, a dwell time of the battery pack 1 in the contact position 3, a temperature of the battery pack 1, a change in temperature of the battery pack 1, a permissible minimum battery voltage of the battery pack 1 and/or a voltage applied to the battery pack, in particular a charging voltage. The method outlined in FIG. 5 detects, as indicated in field 35, an operating parameter of the battery pack 1, by way of example the current battery voltage of the battery pack 1.

According to the decision diamond 45, the operating parameter detected according to field 35, in the example the battery voltage, is compared with a limit value. For example, a minimum permissible battery voltage can be specified as a limit value in order to prevent, for example, deep discharging of the battery pack when used in an electric work apparatus 1.

If the detected operating parameter, for example the battery voltage, is above the specified limit value of a minimum battery voltage, the decision diamond 45 branches to field 37 and from there back to node point 46. The operating parameter of the battery pack 1 is detected once again and compared with the specified limit value again. The operating parameter of the battery pack 1 is repeatedly monitored and compared with the specified limit value.

If the operating parameter, in the example the battery voltage, is equal to or falls below the specified limit value, the decision diamond branches to field 36 and further to field 38, where a disconnection signal T1, T2 is generated. According to field 39, the generated disconnection signal T1, T2 is sent to the disconnection device 10, where it trips the disconnection device (field 50). The electrical connection contacts 2 of the battery pack 1 are mechanically disconnected and/or electrically isolated from the electrical mating contacts 4 of the receptacle 3.

It is understood that the foregoing description is that of the preferred embodiments of the invention and that various changes and modifications may be made thereto without departing from the spirit and scope of the invention as defined in the appended claims.

1. A receptacle for a battery pack with electrical connection contacts, the receptacle comprising:
a plurality of electrical mating contacts corresponding to the electrical connection contacts;
the receptacle being configured to push the battery pack by a push-in distance in a push-in direction into a contact position in the receptacle;
said plurality of electrical mating contacts of the receptacle being electrically conductively connected to the electrical connection contacts of the battery pack in the contact position;
a disconnection device for disconnecting the electrical connection between said plurality of electrical mating contacts and the electrical connection contacts of the battery pack;
said disconnection device being configured to receive a disconnection signal; and,
said disconnection device being configured to disconnect the electrical connection between said plurality of electrical mating contacts and the electrical connection contacts when the disconnection signal is received.

2. The receptacle of claim 1 further comprising:
a monitoring device configured to compare at least one parameter of the battery pack with a specified limit value; and,
said monitoring device being configured to send the disconnection signal to said disconnection device depending on a result of the comparison.

3. The receptacle of claim 1, wherein the receptacle is configured to be connected to a monitoring device configured to compare at least one parameter of the battery pack with a specified limit value; and, the monitoring device is configured to send the disconnection signal to said disconnection device depending on a result of the comparison.

4. The receptacle of claim 2, wherein the at least one parameter of the battery pack is at least one of an end-of-charging voltage of the battery pack, a dwell time of the battery pack in the contact position, a temperature, a change in temperature, a permissible minimum battery voltage of the battery pack, a voltage applied to the battery pack, and a charging voltage applied to the battery pack.

5. The receptacle of claim 3, wherein the at least one parameter of the battery pack is at least one of an end-of-charging voltage of the battery pack, a dwell time of the battery pack in the contact position, a temperature, a change in temperature, a permissible minimum battery voltage of the battery pack, a voltage applied to the battery pack, and a charging voltage applied to the battery pack.

6. The receptacle of claim 1, wherein said disconnection device is a mechanical disconnection device.

7. The receptacle of claim 1, wherein said disconnection device includes a force source for providing a push-out force directed counter to the push-in direction; and, said force source is configured to at least one of:
move the battery pack counter to the push-in direction into an intermediate position; and,
move said plurality of electrical mating contacts of the receptacle in a direction away from the battery pack.

8. The receptacle of claim 7, wherein the receptacle is configured to hold the battery pack secured in the intermediate position.

9. The receptacle of claim 7, wherein said force source is an electrical, pneumatic or mechanical force source.

10. The receptacle of claim 7, wherein said force source is an energy storage device.

11. The receptacle of claim 7, wherein said force source is a spring force accumulator.

12. The receptacle of claim 11, wherein said spring force accumulator is configured to be preloaded by the battery pack pushed into the contact position.

13. The receptacle of claim 1 further comprising a locking device configured to hold the battery pack secured in the contact position.

14. The receptacle of claim 13, wherein said disconnection device is configured to release said locking device.

15. A charger for a battery pack with electrical connection contacts, the charger comprising:
a receptacle having a plurality of electrical mating contacts corresponding to the electrical connection contacts;
said receptacle being configured to push the battery pack by a push-in distance in a push-in direction into a contact position in said receptacle;
said plurality of electrical mating contacts of said receptacle being electrically conductively connected to the electrical connection contacts of the battery pack in the contact position;
a disconnection device for disconnecting the electrical connection between said plurality of electrical mating contacts and the electrical connection contacts of the battery pack;
said disconnection device being configured to receive a disconnection signal; and,
said disconnection device being configured to disconnect the electrical connection between said plurality of electrical mating contacts and the electrical connection contacts when the disconnection signal is received.

16. An electric work apparatus comprising the receptacle of claim 1.

17. A method for protecting a battery pack, wherein the battery pack is pushed by a push-in distance in a push-in direction into a contact position in a receptacle for the battery pack with electrical connection contacts, the receptacle including a plurality of electrical mating contacts corresponding to the electrical connection contacts, the plurality of electrical mating contacts of the receptacle being electrically conductively connected to the electrical connection contacts of the battery pack in the contact position, the receptacle further including a disconnection device for disconnecting the electrical connection between the plurality of electrical mating contacts and the electrical connection contacts of the battery pack, the disconnection device being configured to receive a disconnection signal, and, the disconnection device being configured to disconnect the electrical connection between the plurality of electrical mating contacts and the electrical connection contacts when the disconnection signal is received, the method comprising:
monitoring at least one parameter of the battery pack and comparing the at least one parameter with a specified limit value; and,
generating the disconnection signal depending on a result of said comparing the at least one parameter with the specified limit value and sending the disconnection signal to the disconnection device of the receptacle in order to disconnect the electrical connection contacts of the battery pack from the electrical mating contacts of the receptacle.

18. The method of claim 17, wherein the receptacle is of a charger.

19. The method of claim 17, wherein the receptacle is of an electric work apparatus.
